(19) United States
(12) Patent Application Publication
(10) Pub. No.: US 2012/0155567 A1
(43) Pub. Date: Jun. 21, 2012

(54) DATA TRANSMISSION APPARATUS AND TRANSMISSION METHOD THEREOF

(75) Inventor: Kwangeun KIM, Gyeonggi-do (KR)

(73) Assignee: SAMSUNG ELECTRO-MECHANICS CO., LTD., Gyunggi-Do (KR)

(21) Appl. No.: 13/053,244

(22) Filed: Mar. 22, 2011

(30) Foreign Application Priority Data
Dec. 20, 2010 (KR) 10-2010-0130507

(51) Int. Cl. H04L 27/00

(52) U.S. Cl. 375/295

(57) ABSTRACT

Disclosed herein is a data transmission apparatus including: a clock generating unit generating a clock signal by combining a first unit clock signal and a second unit clock signal formed by delaying the first unit clock signal by a predetermined time; a transmission controlling unit transmitting data in synchronization with the generated clock signal, thereby making it possible to transmit more data at a high speed.

### CROSS REFERENCE(S) TO RELATED APPLICATIONS

This application claims the benefit under 35 U.S.C. Section [120, 119, 119(e)] of Korean Patent Application Serial No. 10-2010-0130507, entitled “Data Transmission Apparatus And Transmission Method Thereof” filed on Dec. 20, 2010, which is hereby incorporated by reference in its entirety into this application.

### BACKGROUND OF THE INVENTION

1. Technical Field

The present invention relates to a data transmission apparatus and a transmission method thereof, and more particularly, to a data transmission apparatus transmitting data in synchronization with a clock signal, and a transmission method thereof.

2. Description of the Related Art

In accordance with development of electronic and computer technologies, information communication between different apparatuses has become gradually important. For example, high speed data transmission between different chips in a circuit board, between different circuit boards in a system, and between different systems has become gradually important.

FIGS. 1A and 1B are timing diagrams showing an operation of a general data transmission apparatus.

Referring to FIGS. 1A and 1B, the data transmission apparatus transmits one data per a period (t0) in synchronization with a clock signal having a predetermined period. In addition, the data transmission apparatus may also transmit two data per a period (t0) in synchronization with a rising edge and a falling edge of the clock signal.

However, since the data transmission apparatus according to the related art has transmitted the data in synchronization with a square wave-shaped clock signal, it has taken a predetermined time to rise and fall the clock signal. Therefore, it has also taken a predetermined time to transmit the data.

That is, since it has taken a long time to rise the clock signal to a first voltage V1 and fall the clock signal to 0 V, it has taken a long time to transmit the data, thereby not keeping pace with the recent trend toward high speed data transmission.

Therefore, the demand for the high speed data transmission has been increased in accordance with a rapidly changing trend.

### SUMMARY OF THE INVENTION

An object of the present invention is to provide a data transmission apparatus capable of transmitting data at a high speed by combining a first unit clock signal and a second unit clock signal formed by delaying the first unit clock signal by a predetermined time to generate a clock signal, and synchronizing the data with the generated clock signal, and a transmission method thereof.

According to an exemplary embodiment of the present invention, there is provided a data transmission apparatus including: a clock generating unit generating a clock signal by combining a first unit clock signal and a second unit clock signal formed by delaying the first unit clock signal by a predetermined time; a transmission controlling unit transmitting data in synchronization with the generated clock signal.

The clock generating unit may include: a first unit clock generating unit generating a first unit clock signal; a second unit clock generating unit generating a second unit clock signal by delaying the first unit clock signal by a predetermined time; and a combining unit combining the first and second unit clock signals to generate the clock signal.

The first unit clock generating unit may include: a signal generator generating a signal having a predetermined shape; and a rectifier rectifying the generated signal to generate the first unit clock signal.

The second unit clock generating unit may include: a phase delay unit delaying the first unit clock signal by a predetermined angle to generate the second unit clock signal, wherein the predetermined angel is 90 degree.

The transmission controlling unit may transmit the data by setting an interval at which one of the first unit clock signal and the second unit clock signal is larger than the other as a period.

The transmission controlling unit may transmit the data at an interval at which the first unit clock signal is larger than the second unit clock signal, and may transmit the data at an interval at which the second unit clock signal is larger than the first unit clock signal.

The signal having a predetermined shape may be a signal having any one of a sinusoidal wave shape, a sawtooth wave shape, a triangular wave shape, or a trapezoidal wave shape.

According to another exemplary embodiment of the present invention, there is provided a transmission method of a data transmission apparatus, including: generating a first unit clock signal; generating a second unit clock signal by delaying the first unit clock signal by a predetermined time; generating a clock signal by combining the first unit clock signal and the second unit clock signal; and transmitting data in synchronization with the generated clock signal.

The generating of the first unit clock signal may include: generating a signal having a predetermined shape; and generating the first unit clock signal by rectifying the generated signal.

The generating of the second unit clock signal may include generating the second unit clock signal by delaying the first unit clock signal by a predetermined angle, wherein the predetermined angle is 90 degree.

The transmitting of the data may include transmitting the data by setting an interval at which one of the first unit clock signal and the second unit clock signal is larger than the other as a period.

The transmitting of the data may include: transmitting the data at an interval at which the first unit clock signal is larger than the second unit clock signal; and transmitting the data at an interval at which the second unit clock signal is larger than the first unit clock signal.

### BRIEF DESCRIPTION OF THE DRAWINGS

FIGS. 1A and 1B are timing diagrams showing an operation of a general data transmission apparatus;

FIG. 2 is a block configuration diagram of a data transmission apparatus according to an exemplary embodiment of the present invention;

FIG. 3 is a detailed configuration diagram of a clock generating unit shown in FIG. 2;

FIG. 4A is a timing diagram of a signal outputted from a signal generator according to an exemplary embodiment of the present invention;

FIG. 4B is a timing diagram of a first unit clock signal outputted from a rectifier according to an exemplary embodiment of the present invention;

FIG. 4C is a timing diagram of a second unit clock signal outputted from a phase delay unit according to an exemplary embodiment of the present invention;

FIG. 4D is a timing diagram of a clock signal outputted from an adder according to an exemplary embodiment of the present invention;

FIG. 4E is a timing diagram of data transmitted from a transmission controlling unit according to an exemplary embodiment of the present invention;

FIG. 5 is an operation flowchart showing a transmission process of a data transmission apparatus according to an exemplary embodiment of the present invention;

FIG. 6A is a timing diagram of a signal outputted from a signal generator according to another exemplary embodiment of the present invention;

FIG. 6B is a timing diagram of a first unit clock signal outputted from a rectifier according to another exemplary embodiment of the present invention;

FIG. 6C is a timing diagram of a second unit clock signal outputted from a phase delay unit according to another exemplary embodiment of the present invention;

FIG. 6D is a timing diagram of a clock signal outputted from an adder according to another exemplary embodiment of the present invention; and

FIG. 6E is a timing diagram of data transmitted from a transmission controlling unit according to another exemplary embodiment of the present invention.

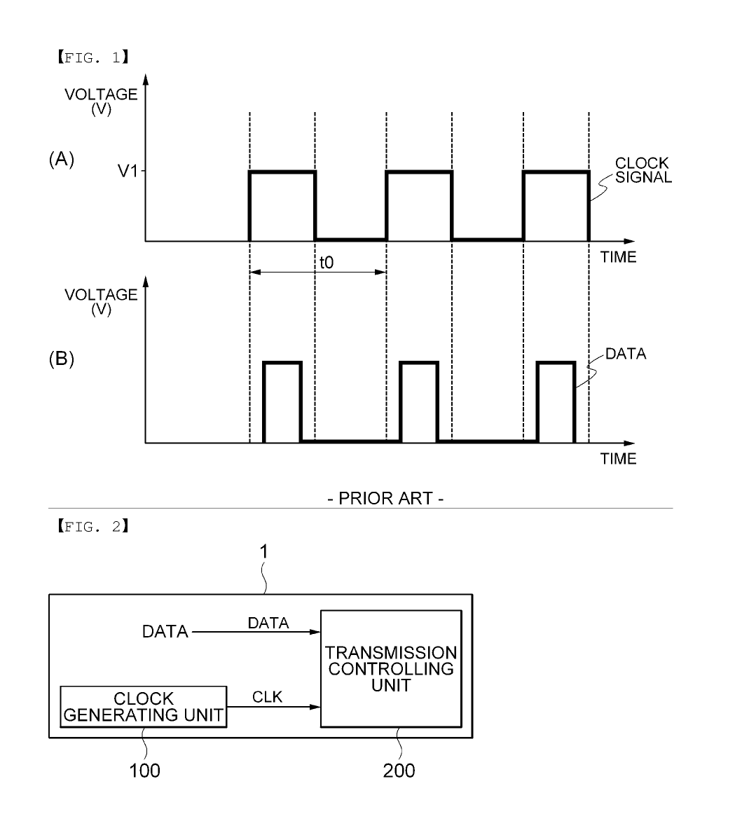

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described in detail with reference to the accompanying drawings.

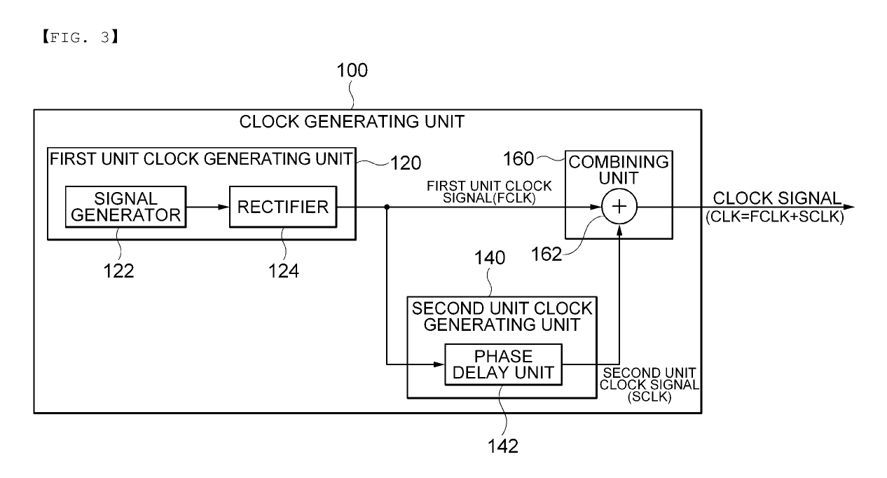

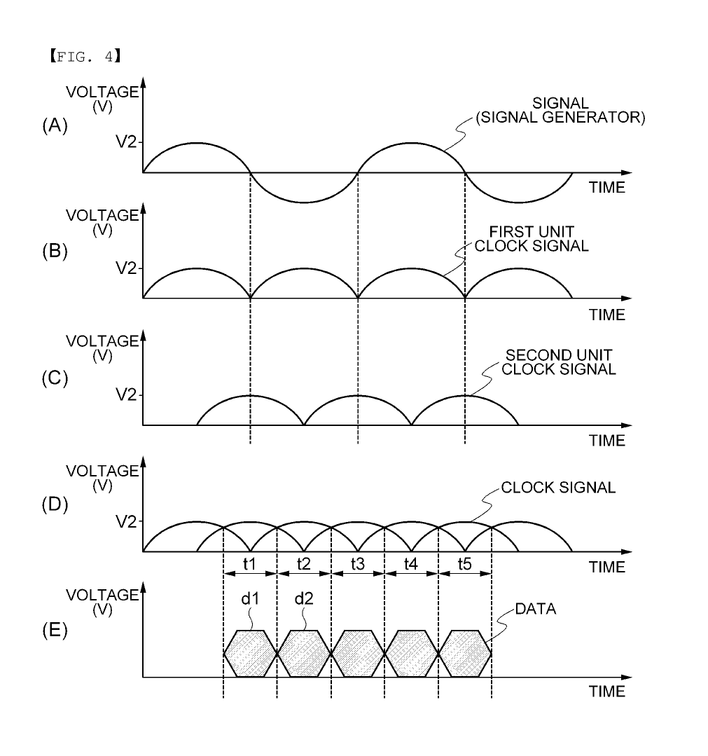

FIG. 2 is a block configuration diagram of a data transmission apparatus according to an exemplary embodiment of the present invention; FIG. 3 is a detailed configuration diagram of a clock generating unit shown in FIG. 2; FIG. 4A is a timing diagram of a signal outputted from a signal generator according to an exemplary embodiment of the present invention; FIG. 4B is a timing diagram of a first unit clock signal outputted from a rectifier according to an exemplary embodiment of the present invention; FIG. 4C is a timing diagram of a second unit clock signal outputted from a phase delay unit according to an exemplary embodiment of the present invention; FIG. 4D is a timing diagram of a clock signal outputted from an adder according to an exemplary embodiment of the present invention; and FIG. 4E is a timing diagram of data transmitted from a transmission controlling unit according to an exemplary embodiment of the present invention.

As shown in FIGS. 2 and 3, a data transmission apparatus 1 is configured to include a clock generating unit 100 generating a clock signal CLK and a transmission controlling unit 200 transmitting data DATA in synchronization with the clock signal CLK.

First, the clock generating unit 100, which is a unit generating the clock signal CLK, includes a first unit clock generating unit 120, a second unit clock generating unit 140, and a combining unit 160.

Among them, the first unit clock generating unit 120 generates a first unit clock signal FCLK, and includes a signal generator 122 and a rectifier 124.

The signal generator 122 generates a predetermined shape (a sinusoidal wave shape in FIG. 4A) of signal having a predetermined output level and a predetermined frequency, as shown in FIG. 4A. In this case, the predetermined shape of signal, which is a signal having a shape with an inclination except for a square wave, may be a signal having various shapes with the inclination such as a sinusoidal wave (a sine wave), a sawtooth wave, a triangular wave, a trapezoidal wave, or the like.

Accordingly, the signal generator 122 may be a sinusoidal wave generator, a sawtooth wave generator, or a triangular wave generator, and may generate a trapezoidal wave by subtracting a sawtooth wave from a sinusoidal wave generated from the sinusoidal wave generator.

As shown in FIG. 4B, the rectifier 124 rectifies the signal generated from the signal generator 122 to generate the first unit clock signal FCLK.

Describing in more detail, the rectifier 124 full wave rectifies an alternating signal having periodically changing two directions such as a positive direction and a negative direction, which is the signal generated from the signal generator 122, to convert the alternating signal into a direct current signal having only one direction, thereby generating the first unit clock signal FCLK.

The second unit clock generating unit 140, which is a unit delaying the first unit clock signal FCLK by a predetermined time to generate a second unit clock signal SCLK, include a phase delay unit 142.

In this configuration, the phase delay unit 142, which is one of compensation circuits, delays a phase of an output signal with respect to a sinusoidal input signal. According to an exemplary embodiment of the present invention, the phase delay unit 142 delays the first unit clock signal by a predetermined angle to generate the second unit clock signal SCLK.

In this case, the predetermined angle is preferably 90 degree. This is the reason that when the first unit clock signal FCLK is delayed by 90 degree to generate the second unit clock signal SCLK, a period t1 of the clock signal CLK may be reduced to be shorter than the period t0 of the clock signal according to the related art and the clock signal CLK may have a predetermined interval.

The combining unit 160, which is a unit combining the first unit clock signal FCLK and the second unit clock signal SCLK to generate the clock signal CLK, includes an adder 162.

Referring to FIG. 4D, the adder 162 combines a plurality of waveforms rather than numerically adding levels of the first unit clock signal FCLK and the second unit clock signal SCLK to generate the clock signal CLK.

The clock signal CLK generated through the above-mentioned scheme has a significantly short period (t1<t0), as compared to the clock signal according to the related art, and has a second voltage V2 significantly smaller than the first voltage V1, such that a time required to rise the clock signal CLK to the second voltage V2 and a time required to fall the clock signal CLK to 0V are reduced.

The transmission controlling unit 200 transmits the data in synchronization with the clock signal CLK generated from the clock generating unit 100.

Describing in more detail, the transmission controlling unit 200 transmits the data by setting an interval at which one of the first unit clock signal FCLK and the second unit clock signal SCLK is larger than the other as a period.

Referring to FIG. 4E, the transmission controlling unit 200 transmits the data at a first interval t2, t4, . . . , which is an interval at which the first unit clock signal FCLK is larger than the second unit clock signal SCLK, and transmits the data at a second interval t1, t3, t5, . . . , which is an interval at which the second unit clock signal SCLK is larger than the first unit clock signal FCLK.

In this case, since the clock signal CLK is a sinusoidal wave signal, it has significantly short rising and falling time, as compared to the square wave clock signal according to the related art, thereby making it possible to transmit more data for the same time.

In addition, the data includes first and second differential data d1 and d2. In contrast with a scheme according to the related art in which the data may be transmitted when predetermined rising and falling times are secured, according to an exemplary embodiment of the present invention, the data may be transmitted when a difference between the first and second differential data is a predetermined value or more. Therefore, more data may be rapidly transmitted.

Hereinafter, a transmission process of a data transmission apparatus according to an exemplary embodiment of the present invention will be described.

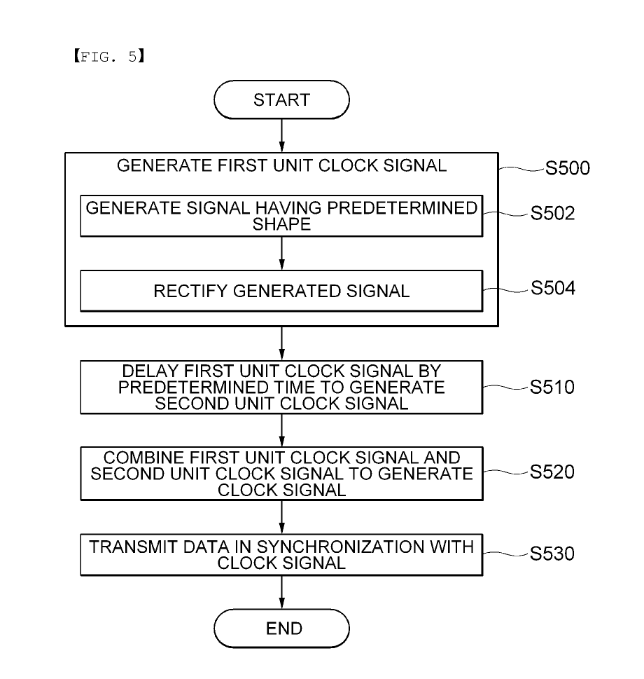

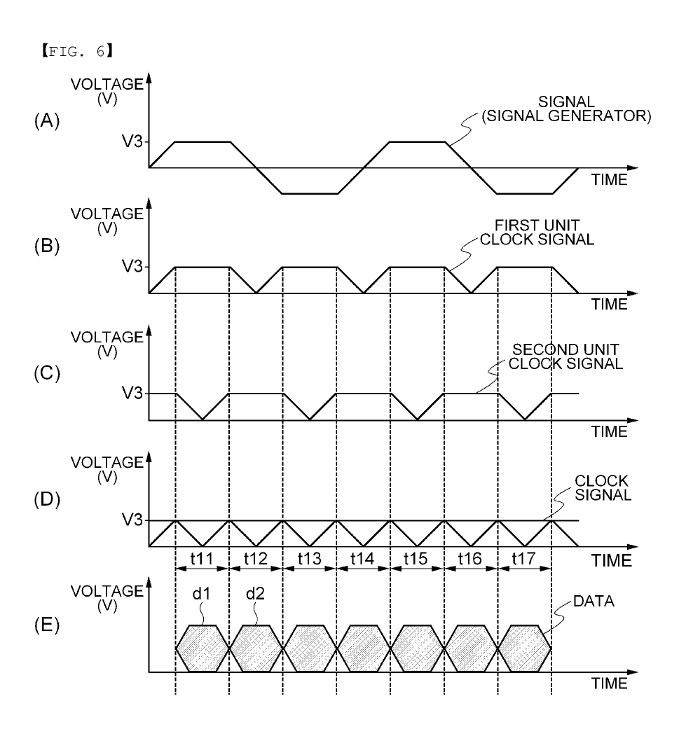

FIG. 5 is an operation flowchart showing a transmission process of a data transmission apparatus according to an exemplary embodiment of the present invention; FIG. 6A is a timing diagram of a signal outputted from a signal generator according to another exemplary embodiment of the present invention; FIG. 6B is a timing diagram of a first unit clock signal outputted from a rectifier according to another exemplary embodiment of the present invention; FIG. 6C is a timing diagram of a second unit clock signal outputted from a phase delay unit according to another exemplary embodiment of the present invention; FIG. 6D is a timing diagram of a clock signal outputted from an adder according to another exemplary embodiment of the present invention; and FIG. 6E is a timing diagram of data transmitted from a transmission controlling unit according to another exemplary embodiment of the present invention.

As shown in FIG. 5, the first unit clock generating unit 120 of the clock generating unit 100 generates the first unit clock signal FCLK (S500).

For this, the signal generator 122 generates a trapezoidal signal as shown in FIG. 6A (S502), and the rectifier 124 rectifies the generated trapezoidal signal as shown in FIG. 6B (S504) to generate the first unit clock signal FCLK.

In this case, the signal generator 122 may generate a trapezoidal wave by subtracting a sawtooth wave from a sinusoidal wave generated from the sinusoidal wave generator 122.

In addition, as shown in FIG. 6C, the second unit clock generating unit 140 delays the first unit clock signal FCLK by a predetermined time to generate the second unit clock signal SCLK (S510).

More specifically, the second unit clock generating unit 140 delays the first unit clock signal FCLK by a predetermined angle to generate the second unit clock signal SCLK, include a phase delay unit 142. In this case, the predetermined angle is preferably 90 degree.

Then, as shown in FIG. 6D, the combining unit 160 combines the first unit clock signal FCLK and the second unit clock signal SCLK to generate the clock signal CLK (S520).

Thereafter, as shown in FIG. 6E, the data is transmitted in synchronization with the generated clock signal CLK (S530).

Describing in more detail, the transmission controlling unit 200 transmits the data by setting an interval at which one of the first unit clock signal FCLK and the second unit clock signal SCLK is larger than the other as a period.

That is, the transmission controlling unit 200 transmits the data at a first interval t11, t13, t15, t17, . . . , which is an interval at which the first unit clock signal FCLK is larger than the second unit clock signal SCLK, and transmits the data at a second interval t12, t14, t16, . . . , which is an interval at which the second unit clock signal SCLK is larger than the first unit clock signal FCLK.

The clock signal CLK generated through the above-mentioned scheme has a significantly short period (t11<t0), as compared to the clock signal according to the related art, and has a third voltage V3 significantly smaller than the first voltage V1, such that a time required to rise the clock signal CLK to the third voltage V3 and a time required to fall the clock signal CLK to 0V are reduced.

Therefore, more data may be rapidly transmitted.

As described above, with the data transmission apparatus and the transmission method thereof according to the exemplary embodiments of the present invention, the first unit clock signal and the second unit clock signal formed by delaying the first unit clock signal by a predetermined time are combined with each other to generate the clock signal and the data is synchronized with the generated clock signal, thereby making it possible to transmit the data at a high speed.

That is, the clock signal formed by combining the first and second unit clock signals has a significantly short period and reduced rising and falling times, as compared to a clock signal according to the related art, thereby making it possible to rapidly transmit more data.

Although the exemplary embodiments of the present invention have been shown and described, the present invention is not limited thereto but various changes and modifications may be made by those skilled in the art without departing from the spirit of the invention.

What is claimed is:

1. A data transmission apparatus comprising:
a clock generating unit generating a clock signal by combining a first unit clock signal and a second unit clock signal formed by delaying the first unit clock signal by a predetermined time;
a transmission controlling unit transmitting data in synchronization with the generated clock signal.

2. The data transmission apparatus according to claim 1, wherein the clock generating unit includes:
a first unit clock generating unit generating the first unit clock signal;
a second unit clock generating unit generating the second unit clock signal by delaying the first unit clock signal by a predetermined time; and
a combining unit combining the first and second unit clock signals to generate the clock signal.

3. The data transmission apparatus according to claim 2, wherein the first unit clock generating unit includes:
a signal generator generating a signal having a predetermined shape; and
a rectifier rectifying the generated signal to generate the first unit clock signal.

4. The data transmission apparatus according to claim 2, wherein the second unit clock generating unit includes:
a phase delay unit delaying the first unit clock signal by a predetermined angle to generate the second unit clock signal.

5. The data transmission apparatus according to claim 4, wherein the predetermined angel is 90 degree.

6. The data transmission apparatus according to claim 1, wherein the transmission controlling unit transmits the data by setting an interval at which one of the first unit clock signal and the second unit clock signal is larger than the other as a period.

7. The data transmission apparatus according to claim 3, wherein the signal having a predetermined shape is a signal having any one of a sinusoidal wave shape, a sawtooth wave shape, a triangular wave shape, or a trapezoidal wave shape.

8. A transmission method of a data transmission apparatus, comprising:
generating a first unit clock signal;
generating a second unit clock signal by delaying the first unit clock signal by a predetermined time;
generating a clock signal by combining the first unit clock signal and the second unit clock signal; and
transmitting data in synchronization with the generated clock signal.

9. The transmission method of a data transmission apparatus according to claim 8, wherein the generating of the first unit clock signal includes:
generating a signal having a predetermined shape; and
generating the first unit clock signal by rectifying the generated signal.

10. The transmission method of a data transmission apparatus according to claim 8, wherein the generating of the second unit clock signal includes generating the second unit clock signal by delaying the first unit clock signal by a predetermined angle.

11. The transmission method of a data transmission apparatus according to claim 10, wherein the predetermined angle is 90 degree.

12. The transmission method of a data transmission apparatus according to claim 8, wherein the transmitting of the data includes transmitting the data by setting an interval at which one of the first unit clock signal and the second unit clock signal is larger than the other as a period.
